(19) United States
(12) Patent Application Publication
(10) Pub. No.: US 2020/0093156 A1
(43) Pub. Date: Mar. 26, 2020

(54) Animal Feed Ingredient

(71) Applicant: Kent Nutrition Group, Inc., Muscatine, IA (US)

(72) Inventors: Sarjit Johal, Iowa City, IA (US); Michael Edmonds, Muscatine, IA (US)

(21) Appl. No.: 15/956,380

(22) Filed: Apr. 18, 2018

Related U.S. Application Data
(60) Provisional application No. 62/489,210, filed on Apr. 24, 2017.

(51) Int. Cl. A23K 20/10; A23K 10/30; A23K 50/30

(52) U.S. Cl. CPC A23K 20/10; A23K 10/30; A23V 2250/154; A23V 2002/00; A23V 2250/02; A23K 50/30

(57) ABSTRACT

Disclosed is a method of feeding an animal, such as swine. Generally, the method comprises administering humic acid and corn steep water to the animal in conjunction with feeding the animal, such as including humic acid and corn steep water with the animal's drinking water. Also disclosed is a composition that comprises humic acid and corn steep water solids, the composition being suitable for addition to an animal's drinking water. The disclosed method and composition are believed suitable for promoting animal weight gain.

### FIELD

The disclosure relates to animal feed compositions and associated methods of preparation and use.

### BACKGROUND

Animal growth promoters and enhancers are materials that facilitate the growth of animals, particularly farm animals such as swine, livestock, poultry, and aquaculture. Generally, the value of such animals to the farmer depends in part on the weight of the animal. Commercially available growth promoters include probiotics, prebiotics, essential oils, botanicals, enzymes, organic acids, phytochemicals, vaccines, RNAs, antibodies, bacteriophage, antimicrobials, innate defense molecules, immune enhancers, and the like. Such animal growth promoters and enhancers may be added directly to feed or to water consumed by animals. There remains room for the development of new growth enhancers.

Use of organic acids as animal growth promoters for feed compositions has been studied. It has been shown that certain levels of a combination of humic acid and butyric acid, specifically protected butyric acid, can increase average daily growth in animals such as poultry and swine. Such combinations of humic acid and protected butyric acid might exhibit a synergistic effect in promoting average daily growth and average daily feed intake in comparison to single organic acids used in comparable amounts. One commercial premix product containing a blend of humic acid and butyric acid is sold under the name HYDRAVANTAGE® by Kent Nutrition Group, Inc. of Muscatine, Iowa.

Humic acid added to animal diets appears to support immune system function. Humic acid is produced by biodegradation of organic matter into humic substance, and is not a single acid but rather a complex mixture of many different acids containing carboxyl and phenolate groups. Humic acid can form complexes with ions that are commonly found in the environment, creating humic colloids.

Butyric acid is a carboxylic acid with the structural formula CH₃CH₂CH₂—COOH. This acid is produced during fermentation and is found in milk, especially goat, sheep, and buffalo milk, butter, and parmesan cheese. Butyric acid triggers potent effects on a variety of gut functions such as inhibiting inflammation and decreasing oxidative stress. However, it is also known to have an odor that is unpleasant to humans, and this material can be difficult to work with.

### SUMMARY

It has been found that a combination of humic acid and corn steep water is an effective substitute at least in part, for the combination of humic acid and butyric acid presently used as an animal feed supplement. Corn steep water is the byproduct of the corn wet milling process, and constitutes the residual water used to steep the corn prior to separation of the germ and starch. The combination of humic acid and corn steep water provides an alternative animal growth promoter that permits recycling of a corn processing byproduct and that lacks the undesirable smell and flavor profile of butyric acid. This combination of humic acid and corn steep water is palatable to swine, and is believed to be about as effective as the commercial combination of humic acid and butyric acid in increasing the weight gain of the animal compared to that of animals without supplemented feed or water. It is also believed that the weight gain may in some embodiments be accompanied by a reduced feed intake, possibly resulting in more efficient weight gain on the basis of feed consumed. In some embodiments, the cost of the humic acid and corn steep water additives might therefore be at least partially offset by the reduction in feed consumption and/or the value of added weight gain.

Provided herein are compositions for promoting animal growth comprising a combination of corn steep water and humic acid. The corn steep water may be provided in liquid form, or may be evaporated or partially evaporated. In some embodiments, an aqueous composition may comprise from about 0.09 to about 0.4 wt. % humic acid and about 4 to about 20 wt. % corn steep water solids, the humic acid and steep water solids being expressed on a dry solids basis. In some embodiments, an animal feed composition may comprise from about 0.15 to about 0.3 wt. % humic acid and about 6 to about 15 wt. % corn steep water solids. In some embodiments, a composition for feeding an animal or for supplementing water or animal feed comprises corn steep water solids and humic acid present in a dry solids ratio relative to one another ranging from 10:1 to 160:1, signifying from 10-160 parts steep water solids to one part humic acid. In some embodiments, the composition may include 6% to 15% dry steep water solids by total weight, humic acid in an amount ranging from 0.15% to 0.3% dry solids by total weight, and butyric acid in an amount ranging from 0.1% to 0.25% dry solids by total weight. In certain embodiments, the composition is provided as a liquid or syrup. In some embodiments, the composition is applied to a carrier such as fiber or plant germ. In some embodiments, the composition may be dried according to known methods to form a powder.

Also provided are methods of promoting weight gain of animals, the methods comprising feeding such compositions to an animal. The animal may be any livestock or pet animal, for instance swine, cattle, or poultry. In some embodiments, the feeding may be effective to promote weight gain relative to an otherwise-similar composition that does not contain a combination of corn steep water and humic acid. In some embodiments, methods of promoting weight gain comprise administering corn steep water and humic acid in conjunction with animal feed over a time span of at least 10 days, with the corn steep water and humic acid being administered in a collective amount effective to promote weight gain over said time span.

In some embodiments, the corn steep water and humic acid are administered in the animal's drinking water. In other embodiments, the corn steep water and humic acid are incorporated into the animal's feed. In some embodiments, the corn steep water is administered in an amount ranging from 4 wt. % to 20 wt. % dry steep water solids by total weight and the humic acid being administered in an amount ranging from 0.09 wt. % to 0.4 wt. % dry solids by total weight

Further provided is a method of preparing supplemented water or animal feed. This method generally comprises blending corn steep water solids and humic acid with water and/or feed components to form a mixture, and in the case of supplemented feed optionally forming the mixture into pellets.

### DETAILED DESCRIPTION

In various, non-mutually-exclusive embodiments, the invention provides animal growth-promoting compositions including humic acid and corn steep water, methods of administering such compositions, methods of promoting weight gain in animals through administration of such compositions, and methods of making such compositions. As discussed in more detail below, compositions incorporating a combination of humic acid and corn steep water are palatable to animals, in particular swine, and in some cases may enhance weight gain and may result in a desirable lower ratio of feed intake to weight gain.

Corn steep liquor, also known as corn steep water, light steep water, heavy steep water, and condensed fermented corn extractives, is a viscous concentrate of corn solubles which is a byproduct of wet milling and contains amino acids, vitamins, and minerals. When corn-based food products are manufactured for human consumption, byproducts are produced that are not suitable for human consumption. Corn steep water is one such byproduct. This product generally exists in liquid form, and is derived from cleaning of corn after shelling but prior to germ separation and milling. Light corn steep water is concentrated by evaporation to heavy steep water, corn steep liquor, or condensed fermented corn extractives. Corn steep water is a brownish appearing material with a texture similar to that of pudding. Containing some amount of lactic acid due to partial fermentation, corn steep water has an acidic pH (about 3.2 to about 4.1). As used herein, the term “corn steep water” refers to a liquid byproduct of corn processing, and includes corn steep water and corn steep liquor of various concentrations. In some embodiments the corn steep water may comprise a liquid having about 12-15% solids, a syrup having about 30-50% solids, or a solid or semi-solid material.

The humic acid may be commercially produced or obtained as a part of humic matter, and it will be appreciated that humic acids obtained from any process may be used to feed animals and promote weight gain as described herein. There are many different humic acid deposits and sources throughout the world that produce various unprocessed as well as enriched forms. The mineral and organic compositions of these materials differ. Humic acid material used in the Examples below was extracted from a fresh water deposit, the Menefee formation in New Mexico, although other sources of humic acid may also be utilized.

A composition comprising corn steep water and humic acid may be administered to an animal along with animal feed composition, for instance by adding the composition to water administered to the animal generally contemporaneously with the animal feed composition, and in some embodiments may be incorporated into the animal feed itself. By administering corn steep water is contemplated the provision of corn steep water solids, whether present in the form of corn steep water itself, a concentrated or diluted form of corn steep water, or a dried or partially dried form of corn steep water solids. Similarly, by administering humic acid is contemplated the administration of humic acid solids, whether in liquid or solid form. In some embodiments, a composition for feeding an animal or for supplementing water or animal feed comprises corn steep water solids and humic acid present in a dry solids ratio relative to one another ranging from 10:1 to 160:1, again, signifying from 10-160 parts steep water solids to one part humic acid. In some embodiments, an amount of the composition is provided to an animal so that the animal receives about 100 milligrams of humic acid per day.

In some embodiments, the composition may contain butyric acid as an optional ingredient. When present, the humic acid should be present in a greater amount than the amount of butyric acid. In some embodiments, the humic present in an amount ranging from 130% to 170% of the amount of butyric acid on a dry solids basis. For example, corn steep water may be administered in an amount ranging from 6% to 15% dry steep water solids by total weight, the humic acid may be administered in an amount ranging from 0.15% to 0.3% dry solids by total weight, and the butyric acid may be administered in an amount ranging from 0.1% to 0.25% dry solids by total weight.

In certain embodiments, a composition is provided as a liquid or syrup to be added to the animal's water or feed. The composition contains corn steep water and humic acid, and optionally butyric acid. The composition also may include other ingredients as may be appropriate for the animal feed.

The animal feed composition administered to the animal in conjunction with the corn steep water and humic acid combination may include, for instance, a fat. It is contemplated that any animal and/or vegetable fat may be useful in conjunction with the animal feed composition. Suitable examples of vegetable fat include corn oil and soy oil. For instance, in some embodiments full-fat corn germ is used as a starting material in fabricating the animal feed. An example of a suitable animal fat is choice white grease, a swine-derived fat. However, particularly in light of the growing concern over incorporation of animal by-products into animal feeds, preferred embodiments of the invention do not include animal fat.

When employed, fat may be present in the animal feed in any amount effective to provide nutritive fat to the animal. It is contemplated that the fat content may vary depending upon the animal or upon the intended nutritive qualities of the feed. Generally, it is preferred that the fat is present in the animal feed in an amount of at least 5% by weight of the feed, and generally not over 10% fat in the complete feed. It is contemplated that two or more fat sources may be included in the feed; if such is the case, the total fat amount preferably falls within one of these foregoing ranges.

The animal feed further includes a solid nutritive source. Any suitable solid nutritive source may be used in conjunction with the invention, and thus, for instance, the solid nutritive source may comprise a whole grain, such as whole wheat, whole rice, whole corn, or whole barley. The solid nutritive source alternatively may comprise a nutritive grain fraction, such as nutritive wheat, nutritive rice, nutritive corn, or nutritive barley fraction. Other nutritive sources include those derived from soy, oats, sorghum, and the like. The nutritive source may include other nutritive sources, including sources (such as molasses solids) that are initially provided in liquid form. The solid nutritive source may be present in the animal feed in any suitable amount. In the case of a somewhat low-fat feed, it is contemplated that the solid nutritive source may be present in an amount of 95% or greater. In more preferred embodiments of the invention, the solid nutritive source is present in an amount of at least about 60%, more preferably an amount of at least about 70% by weight of the animal feed.

It is preferred that the nutritive source include a protein source, which may be present in any amount effective to provide protein to the animal. Protein preferably is present in an amount ranging from about 10% to about 30% by weight of the animal feed. Young swine are particularly needy of protein, with protein contents in the 20% to 25% range. More preferably, for feeds for other animals, the protein is present in an amount ranging from about 10% to about 30% by weight of the animal feed; even more preferably, the protein is present in an amount ranging from about 15% to about 20% by weight of the animal feed.

It is further preferred that the animal feed include a fiber source. Generally, sources of fiber, such as soybean hulls, rice hulls, corn hulls, cottonseed, wheat hulls, and the like are considered largely non-nutritive (at least in the case of non-ruminant animals). In any case, regardless of whether the animal feed is intended for use by ruminants, the feed preferably includes such fiber source in an amount effective to provide fiber to the animal. Different feed formulas for different animals vary greatly in the amount of fiber desired. Preferably, the fiber source is prepared in an amount ranging from about 1% to about 25% by weight of the animal feed, the percentage being expressed by the bulk weight of the hulls or other source.

The feed may further include additional materials. For instance, the feed may include one or more vitamins or nutritive minerals, or, more generally, any other suitable nutritive source or other suitable ingredients. As but one example, the feed may include one or more antibiotics. More generally, the foregoing discussion is intended to provide guidelines as to the amount of ingredients suitable for use in the compositions of the invention. The actual composition of an animal feed may vary, depending on factors such as the type of animal and the desired levels of fat, fiber, nutrients, and other materials.

The humic acid and corn steep water composition may be administered to an animal in liquid or in solid form. For instance, unconcentrated corn steep water and liquid or powder humic acid may be added to the animal's drinking water. In one example, corn steep water having 12-15% solids by weight may be added to the animal's drinking water in an amount of about 3 parts steep water to 2 parts water by volume, along with about 50 milligrams per gallon of humic acid. In another form, the steep water may be concentrated as a stabilized syrup having about 30-40% solids by weight, which may then be added to humic acid and provided to users for incorporation into drinking water or dry feed. In yet another form, the humic acid and corn steep water may be dried to form a powder using conventional techniques such as spray drying. In some embodiments, the composition is provided on a carrier such as fiber or plant germ.

The humic acid and corn steep water composition prepared in accordance with the present teaching may be administered to animals in varying amounts as appropriate for a particular animal to advantageously increase both feed intake and weight gain as compared to conventional diets.

The animal feed compositions described herein may be prepared and tailored for, and advantageously administered to, a variety of animals, including but not limited to, ruminant and monogastric meat producing animals such as beef and dairy cattle, swine, sheep, lambs and goats, farm livestock including equine animals, poultry such as chickens, ducks, turkeys, and aquaculture farmed fish and shrimp for human consumption. Also contemplated are feed products for pet animals such as cats and dogs.

In some embodiments, the invention contemplates administering corn steep water and humic acid in conjunction with animal feed over a time span of at least ten days, for example, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, or at least 30 days. In some instances, this period of administration is followed by discontinuing the administration of the corn steep water and humic acid for a period of at least ten days, for example, a subsequent period of 10, 11, 12, 13, 14, 15, 16, 17, 18, 19, or 20 days, or indefinitely.

Advantages and embodiments of the growth promoting composition described herein are further illustrated by the following non-limiting examples.

### Example 1

To ascertain the effect of a combination of humic acid and corn steep water on weight gain and feed intake, four hundred eighty (480) weanling pigs (20 days old) were randomly divided into four groups. The first group was designated as a control group and received plain water along with feed. The second group received a Comparative (non-inventive) Formula of water supplemented with humic acid (54 milligrams) and butyric acid (211 milligram per gallon of treated water) representing use of commercially available growth promoters such as HydraVantage (Kent Nutrition Group, Inc.). The third group of pigs received Inventive Formula 1, which included approximately 1 gallon of corn steep water and 6.9 grams humic acid for every 128 gallons of ordinary water. Finally, the fourth group of pigs received Inventive Formula 2, which was identical to Inventive Formula 1 except that it also included butyric acid in an amount of 20% of the dose supplied in the Comparative Formula. Pigs were kept 8 or 9 per pen and had an initial average body weight of 13.9 lbs. All four groups of pigs were fed the same dry feed (NexGen 12-17 Complete, Kent Nutrition Group) ad libitum along with their respective water formulations for a period of 28 days, with the pigs weighed on days 9 and 28 of the study.

As shown in Table 1 below, the Comparative Formula was linked to a significant overall increase in average daily weight gain with a less significant increase in average daily feed intake when compared to the Control group. Thus, at day 9 the group receiving the Comparative Formula containing humic and butyric acids gained an average of 19.3% more weight relative to Control pigs consuming plain water, but consumed only 10.4% more feed, decreasing the amount of feed consumed to gain a specified amount of weight by 14.6%.

Inventive Formula 1, including the same amount of humic acid as the Comparative Formula but containing Corn Steep water in place of butyric acid, similarly increased average daily gain with a less significant rise in feed intake relative to plain water. Formula 1 also decreased the amount of feed to gain a specified amount of weight by 14.6% at day 9, signifying a significant increase in feed efficiency. Thus, Formula 1 in this experiment was shown to be comparable to the commercial supplement (Comparative Formulation) in reducing the amount of feed per pound weight gain, and significantly more effective than water alone in promoting weight gain and decreasing feed per pound weight gain. By day 28, average daily weight gain was still improved relative to the Control group.

Inventive Formula 2 was even more effective than the Comparative Example at day 9, increasing average daily weight gain by 30% relative to plain water while increasing feed intake by only 4.6%, resulting in a reduction of feed per pound weight gain of 31%. At day 28, results were comparable to the Comparative Example and demonstrated significantly improved weight gain compared to the Control.

TABLE 1
Weight Gain, Feed Intake, And Feed Efficiency In Nursery Pigs (Example 1)

| | | | | | | Formula | Formula |
|---|---|---|---|---|---|---|---|
| | | Comparative | | | Comp. | 1 vs | 2 vs |
| | Control | Formula | Formula 1 | Formula 2 | vs Cont. | Control | Control |
| Humic Acid | | ✓ | ✓ | ✓ | | | |
| Butyric Acid | | ✓ | | 1/5✓ | | | |
| Corn Steep | | | ✓ | ✓ | | | |
| water | | | | | | | |
| Days 0-9 | | | | | | | |
| Avg. Daily | .140 | .167 | .154 | .182 | +19.3% | +10% | +30.0% |
| Gain (lbs.) | | | | | | | |
| Avg. Daily | .258 | .285 | .269 | .270 | +10.4% | +4.3% | +4.6% |
| Feed (lbs.) | | | | | | | |
| Feed/Gain | 2.389 | 2.043 | 2.043 | 1.654 | −14.6% | −14.6% | −31.0% |
| Days 0-28 | | | | | | | |
| Avg. Daily | .663 | .691 | .671 | .684 | +4.2% | +1.2% | +3.2% |
| Gain (lbs.) | | | | | | | |
| Avg. Daily | .889 | .932 | .899 | .926 | +4.8% | +1.1% | +4.1% |
| Feed (lbs.) | | | | | | | |
| Feed/Gain | 1.341 | 1.348 | 1.342 | 1.356 | +0.5% | — | +1.1% |

### Example 2

The same protocol was followed as described in Example 1 for another group of four hundred eighty (480) weanling pigs (20 days old), except that pigling weight was assessed at days 10 and 26. Initial average weight was 13.8 lbs. The results are shown below in Table 2.

TABLE 2
Weight Gain, Feed Intake, And Feed Efficiency In Nursery Pigs (Example 2)

| | | | | | Comp. | Formula | Formula |
|---|---|---|---|---|---|---|---|
| | | Comparative | | | vs | 1 vs | 2 vs |
| | Control | Formula | Formula 1 | Formula 2 | Control | Control | Control |
| Humic Acid | | ✓ | ✓ | ✓ | | | |
| Butyric Acid | | ✓ | | 1/5✓ | | | |
| Corn Steep | | | ✓ | ✓ | | | |
| water | | | | | | | |
| Days 0-10 | | | | | | | |
| Avg. Daily | .219 | .207 | .241 | .222 | −5.5% | +10.0% | +1.4% |
| Gain (lbs.) | | | | | | | |
| Avg. Daily | .313 | .301 | .310 | .301 | −3.8% | −0.9% | −3.8% |
| Feed (lbs.) | | | | | | | |
| Feed/Gain | 1.496 | 1.500 | 1.368 | 1.439 | — | −8.5% | −3.8% |
| Days 0-26 | | | | | | | |
| Avg. Daily | .634 | .641 | .644 | .610 | +1.1% | +1.6% | −3.8% |
| Gain (lbs.) | | | | | | | |
| Avg. Daily | .835 | .828 | .838 | .807 | −0.8% | +0.4% | −3.3% |
| Feed (lbs.) | | | | | | | |
| Feed/Gain | 1.319 | 1.290 | 1.311 | 1.324 | −2.2% | −0.6% | +0.4% |

As seen above, Formulas 1 and 2 resulted in greater average daily weight gain than the Control at day 10, similar to the Comparative Formula.

### Example 3

The same protocol was followed as described in Example 1 for another group of four hundred eighty (480) weanling pigs (20 days old), except that pigling weight was assessed at days 10 and 26 and there were 11 to 13 pigs per pen. Average starting weight was 14.4 lbs. The results are shown below in Table 3.

TABLE 3
Weight Gain, Feed Intake, And Feed Efficiency In Nursery Pigs (Example 3)

| | | | | | Comp. | Formula | Formula |
|---|---|---|---|---|---|---|---|
| | | Comparative | | | vs | 1 vs | 2 vs |
| | Control | Formula | Formula 1 | Formula 2 | Cont. | Control | Control |
| Humic Acid | | ✓ | ✓ | ✓ | | | |
| Butyric Acid | | ✓ | | 1/5✓ | | | |
| Corn Steep | | | ✓ | ✓ | | | |
| water | | | | | | | |
| Days 0-10 | | | | | | | |
| Avg. Daily | .342 | .353 | .349 | .296 | +3.2% | +2.0% | −13.5% |
| Gain (lbs.) | | | | | | | |
| Avg. Daily | .367 | .365 | .373 | .364 | −0.5% | +1.6% | −0.8% |
| Feed (lbs.) | | | | | | | |
| Feed/Gain | 1.107 | 1.076 | 1.082 | 1.280 | −2.8% | −2.2% | +15.6% |
| Days 0-26 | | | | | | | |
| Avg. Daily | .616 | .622 | .640 | .615 | +1.0% | +3.9% | — |
| Gain (lbs.) | | | | | | | |
| Avg. Daily | .830 | .842 | .852 | .833 | +1.4% | +2.6% | +0.4% |
| Feed (lbs.) | | | | | | | |
| Feed/Gain | 1.350 | 1.352 | 1.332 | 1.357 | — | −1.3% | +0.5% |

As seen above, Formula 1 resulted in greater average daily weight gain and better feed efficiency than the Control at days 10 and 26.

### Example 4

The same protocol was followed as described in Example 1 for another group of four hundred eighty (480) weanling pigs (20 days old), except that pigling weight was assessed at days 9 and 26 and there were 11 to 13 pigs per pen. Average starting weight was 14.0 lbs. The results are shown below in Table 4.

TABLE 4
Weight Gain, Feed Intake, And Feed Efficiency In Nursery Pigs (Example 4)

| | | | | | Comp. | Formula | Formula |
|---|---|---|---|---|---|---|---|
| | | Comparative | | | vs | 1 vs | 2 vs |
| | Control | Formula | Formula 1 | Formula 2 | Cont. | Control | Control |
| Humic Acid | | ✓ | ✓ | ✓ | | | |
| Butyric Acid | | ✓ | | 1/5✓ | | | |
| Corn Steep | | | ✓ | ✓ | | | |
| water | | | | | | | |
| Days 0-9 | | | | | | | |
| Avg. Daily | .251 | .255 | .260 | .247 | +1.6% | +3.6% | −1.6% |
| Gain (lbs.) | | | | | | | |
| Avg. Daily | .322 | .314 | .328 | .315 | −2.5% | +1.9% | −2.1% |
| Feed (lbs.) | | | | | | | |
| Feed/Gain | 1.302 | 1.261 | 1.296 | 1.330 | −3.1% | −0.5% | +2.2% |
| Days 0-26 | | | | | | | |
| Avg. Daily | .639 | .649 | .664 | .643 | +1.6% | +3.9% | +0.6% |
| Gain (lbs.) | | | | | | | |
| Avg. Daily | .827 | .827 | .858 | .832 | — | +3.7% | +0.6% |
| Feed (lbs.) | | | | | | | |
| Feed/Gain | 1.297 | 1.277 | 1.296 | 1.298 | −1.5% | — | — |

As seen above, Formula 1 resulted in more significant average daily weight gain than the Comparative Example and the Control at days 9 and 26.

Table 5 below shows a compilation of results from Examples 1-4.

TABLE 5
Overall Weight Gain, Feed Intake, And Feed Efficiency In Nursery Pigs

| | | | | | Comp. | Formula | Formula |
|---|---|---|---|---|---|---|---|
| | | Comparative | | | vs | 1 vs | 2 vs |
| | Control | Formula | Formula 1 | Formula 2 | Cont. | Control | Control |
| Humic Acid | | ✓ | ✓ | ✓ | | | |
| Butyric Acid | | ✓ | | 1/5✓ | | | |
| Corn Steep | | | ✓ | ✓ | | | |
| water | | | | | | | |
| Days 0-9 | | | | | | | |
| Avg. Daily | .229 | .236 | .242 | .231 | +3.0% | +5.7% | +0.9% |
| Gain (lbs.) | | | | | | | |
| Avg. Daily | .310 | .312 | .315 | .308 | +0.6% | +1.6% | −0.6% |
| Feed (lbs.) | | | | | | | |
| Feed/Gain | 1.953 | 1.520 | 1.490 | 1.440 | −22.1% | −23.7% | −26.2% |
| Days 0-26 | | | | | | | |
| Avg. Daily | .640 | .653 | .655 | .639 | +2.0% | +2.3% | — |
| Gain (lbs.) | | | | | | | |
| Avg. Daily | .848 | .861 | .863 | .852 | +1.5% | +1.7% | +0.5% |
| Feed (lbs.) | | | | | | | |
| Feed/Gain | 1.327 | 1.317 | 1.321 | 1.335 | −0.7% | −0.4% | +0.6% |

As seen above, Formula 1 generally resulted in more significant average daily weight gain than the Comparative Example and the Control at days 9 and 26. Formula 2 also generally showed an increase in weight gain and improved feed efficiency over the Control at day 9.

### Example 5

A group of one hundred ninety six (196) weanling pigs (20 days old) was grouped into pens with seven pigs per pen. Control pigs received plain water for 33 days. The remaining pigs received Inventive Formula 2 as described in Example 1 (a mixture of humic acid, corn steep water, and 20% of the level of butyric acid from the Comparative Formula in Examples 1-4) for days 0-11, then plain water for days 11-33. Pigling weight was assessed at days 11 and 33. Average starting weight was 12.6 lbs. The results are shown below in Table 6.

TABLE 6
Weight Gain, Feed Intake, Feed Efficiency and Death
Loss in Nursery Pigs

| | | | Formula 2 vs |
|---|---|---|---|
| | Control (C) | Formula 2 | Control |
| Humic Acid | | √ | |
| Butyric Acid | | 1/5√ | |
| Gluten-Processed Water | | √ | |
| Days 0-11 | | | |
| Average Daily Gain (lbs.) | .230 | .247 | +7.4% |
| Average Daily Feed (lbs.) | .336 | .331 | −1.5% |
| Feed/Gain | 1.482 | 1.374 | −7.3% |
| Days 0-33 | | | |
| Average Daily Gain (lbs.) | .787 | .817 | +3.8% |
| Average Daily Feed (lbs.) | 1.076 | 1.092 | +1.5% |
| Feed/Gain | 1.368 | 1.336 | −2.3% |
| Percent dead pigs | 6.12 | 1.02 | −83% |

As seen above, the use of Inventive Formula 2 resulted in greater weight gains and better feed efficiencies than the Control at days 11 and 33. In addition, and surprisingly, death loss was significantly reduced for pigs on Formula 2 than those on the Control.

The foregoing descriptions are not intended to represent the only forms of the animal feed compositions in regard to the details of the formulation. Changes in form and in proportion of parts, as well as the substitution of equivalents, are contemplated as circumstances may suggest or render expedient. More generally, all methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention unless otherwise claimed. No language in the specification should be construed as indicating any non-claimed element as essential to the practice of the invention. This invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of feeding an animal, comprising:
administering corn steep water and humic acid in conjunction with animal feed over a time span of at least ten days, said corn steep water and humic acid being administered in a collective amount effective to promote weight gain over said time span.

2. A method according to claim 1, said corn steep water and humic acid being administered in said animal's drinking water.

3. A method according to claim 2, said corn steep water being administered in an amount ranging from 6% to 15% dry steep water solids by total weight and said humic acid being administered in an amount ranging from 0.15% to 0.3% dry solids by total weight.

4. A method according to claim 2, said animal comprising swine.

5. A method according to claim 1, further comprising administering butyric acid to said animal.

6. A method according to claim 5, said corn steep water being administered in an amount ranging from 6% to 15% dry steep water solids by total weight, said humic acid being administered in an amount ranging from 0.15% to 0.3% dry solids by total weight, and said butyric acid being administered in an amount ranging from 0.1% to 0.25% dry solids by total weight.

7. A method of feeding an animal, comprising:
administering corn steep water and humic acid in said animal's drinking water over a time span of at least ten days, said corn steep water being administered in an amount ranging from 6% to 15% dry steep water solids by total weight and said humic acid being administered in an amount ranging from 0.15% to 0.3% dry solids by total weight.

8. A method according to claim 7, said animal comprising swine.

9. A method according to claim 8, said animal comprising plural swine.

10. A method according to claim 7, further comprising administering butyric acid to said animal.

11. A method according to claim 10, said butyric acid being administered in an amount ranging from 0.1% to 0.25% dry solids by total weight.

12. A method according to claim 10, including administering the corn steep water and humic acid in said animal's drinking water over a time span of at least ten days, then discontinuing the administration of the corn steep water and humic acid for a period of at least ten days.

13.-16. (canceled)
